(19) United States
(12) Patent Application Publication
(10) Pub. No.: US 2006/0052524 A1
(43) Pub. Date: Mar. 9, 2006

(54) Urethane acrylate composition

(76) Inventors: David D. Peters, Wyandotte, MI (US); Calvin T. Peeler, Canton, MI (US)

Correspondence Address: BASF AKTIENGESELLSCHAFT, CARL-BOSCH STRASSE 38, 67056 LUDWIGSHAFEN, LUDWIGSHAFEN, 69056, DE

(21) Appl. No.: 10/935,437

(22) Filed: Sep. 7, 2004

(51) Int. Cl. C08G 18/08

(52) U.S. Cl. 524/589

(57) ABSTRACT

A urethane acrylate composition includes a resin system and a catalyst system. The resin system includes a urethane acrylate adduct including a reaction product of an isocyanate component and a functionalized acrylate reactive with the isocyanate component. The resin system also includes a first metal salt and a second metal salt. The catalyst system includes a peroxide. The catalyst system catalyzes a free-radical reaction of the urethane acrylate composition. The resin and catalyst systems may be used in a method of making a composite structure in a mold. The method includes applying a first layer and the urethane acrylate composition to the mold. The method further includes curing the structure in the mold and demolding the structure from the mold.

### FIELD OF THE INVENTION

The subject invention generally relates to a urethane acrylate composition. The invention also relates to a method of catalyzing the urethane acrylate composition and a method of making a composite structure that includes the urethane acrylate composition. More specifically, the subject invention relates to a urethane acrylate composition that includes a catalyst system.

### DESCRIPTION OF THE RELATED ART

Conventional urethane acrylate compositions are known in the art. Conventional urethane acrylate compositions are used to form composite structures. Generally, these urethane acrylate compositions include the reaction product of an isocyanate component and a functionalized acrylate reactive with the isocyanate component. In many cases, catalyst systems are used in the reaction between the isocyanate component and the functionalized acrylate to form the urethane acrylate composition.

Efforts have been made to improve catalysis of the reaction between the isocyanate component and the functionalized acrylate. The efforts include an alteration of a reaction temperature profile, an alteration of the catalysis of the reaction between the isocyanate component and the functionalized acrylate, and an inhibition of the isocyanate component and the functionalized acrylate.

Prior art catalyst systems utilized to form the composite structures include organic peroxides, metal salts, and accelerators. The prior art catalyst systems are deficient because of an inability to effectively catalyze a cross-linking reaction between the functionalized acrylate and a reactive diluent that allows the urethane acrylate composition to cure at room temperature. Also, the composite structures formed from the urethane acrylate compositions are deficient without additional high temperature post-curing or extended curing at ambient temperatures.

One conventional urethane acrylate composition is disclosed in U.S. Pub. No. 2002/0173593 to Udding, et al. The '593 publication discloses the use of a resin system and a catalyst system. The resin system can include; an isocyanate based quasi-prepolymer formed by a reaction of two molar equivalents of diphenyl methane diisocyanate and one molar equivalent of dipropylene glycol, a functionalized acrylate, and a reactive diluent such as methyl methacrylate. The resin system, alternatively, can be composed of a moderately low weight unsaturated polyester with 1 to 4 repeating units. The catalyst system can include a peroxide such as cumene hydroperoxide, cobalt carboxylate, which is a metal salt, and N,N-dimethyl-p-toluidine, which is an accelerator. The catalyst system may alternatively include multiple metal salts such as cobalt octoate or potassium carboxylate in addition to benzoyl peroxide and N,N-dimethyl-p-toluidine. Importantly, the '593 publication does not disclose the inclusion of a metal salt within the resin system which may result in a less homogeneous mixing of the resin system and the catalyst system. Adding the peroxide as a solid or a solid dispersion, as disclosed in the '593 publication, results in less homogeneous mixing. This less homogeneous mixing of the peroxide can result in varied temperatures and reaction rates across the composite article due to a variation in a distribution of the catalyst system. The varied temperatures and reaction rates may cause inconsistent curing of the urethane acrylate composition and lead to inconsistent physical properties of the urethane acrylate composite article due to thermal stressing. Therefore, the '593 patent is unsuitable for use to produce a urethane acrylate composition with consistent curing properties and consistent physical properties of the resultant urethane acrylate composite article.

An additional prior art urethane acrylate composition is disclosed in U.S. Pat. No. 5,770,653 to Matsukawa, et al. The '653 patent also discloses the use of a resin system and an anionic catalyst system. The resin system includes an isocyanate component and a functionalized acrylate. The anionic catalyst system includes a curing agent, such as cumene hydroperoxide, a cure promoter such as a metal octoate, and an accelerator such as N,N-dimethyl-p-toluidine. Yet, the '653 patent does not disclose a resin system including a metal salt. The '653 patent also does not disclose potassium octoate. The metal octoates that are disclosed in the '653 patent supply the anionic catalyst system with a redox potential which affords anionic curing. Potassium octoate is not disclosed in the '653 patent because potassium octoate would not supply the same redox potential or afford the same anionic curing. Therefore, the '653 patent is unsuitable for use to produce a urethane acrylate composition that can be cured at room temperature within a short period of time, as evidenced in examples in the '653 patent that include cure times of 24 hours and high temperature curing.

U.S. Pat. No. 6,136,883 to Yang, et al. also discloses the use of a resin system and a catalyst system which, when reacted, form a modified polyester-polyurethane. The resin system includes an isocyanate component and a peroxide. The catalyst system includes a combination of a polyester polyol, an ethylenically unsaturated monomer such as styrene, a functionalized acrylate, a promoter such as cobalt carboxylate, an accelerator such as N,N-dimethyl-p-toluidine, a urethane reaction catalyst such as a tertiary amine, a strong base, a salt of an organic acid, and a carbonyl metal of cobalt or other organometallic compound. The '883 patent also discloses that the resin system and the catalyst system are designed to cure between 80° C. and 150° C., which is significantly above room temperature. The '883 patent does not disclose a resin system including a metal salt. The '883 patent also does not disclose a catalyst system that allows the urethane acrylate composition to cure at room temperature. When combined, the resin system and the catalyst system, as disclosed in the '883 patent, will have a limited effective lifetime due to a high reactivity of the isocyanate component, the polyester polyol, and the functionalized acrylate. This high reactivity may produce excess heat and prematurely activate the peroxide, which would negatively affect physical properties of the modified polyester-polyurethane because of a random nature in which the prematurely activated peroxide may react with the isocyanate component, the polyester polyol, and the functionalized acrylate. Therefore, the '883 patent is unsuitable for use to produce a urethane acrylate composition that can be consistently cured at room temperature within a short period of time and with consistent physical properties.

The conventional urethane acrylate compositions, as discussed above, have been used within the boating, automotive parts, and building supplies industries as coating systems but not in composite structure applications. These conventional urethane acrylate compositions are not suitable for use to produce composite structures that are formed by many typically employed process methods such as spray, pour, and molding applications, for various reasons. For example, the viscosities of the conventional urethane acrylate compositions are very high and are unsuitable for spray, pour, and molding applications, applications with long reaction times of greater than 24 hours, and applications with long post-cure times at elevated temperatures and at elevated pressures. The conventional urethane acrylate compositions also have a short storage lifetime and a limited effective lifetime. Also, the resin system or the catalyst system containing any free, un-reacted isocyanate groups could react with moisture thereby forming carbon dioxide gas, which would cause the urethane acrylate composition to have inconsistent physical properties. The conventional urethane acrylate compositions also have not been optimized to cure at room temperature within a short period of time and have limited processing latitude. Furthermore, these conventional urethane acrylate compositions yield poor surface curing which results in sticky or tacky support layers and require a high temperature post-cure to yield a suitable composite structure.

### SUMMARY OF THE INVENTION AND ADVANTAGES

The subject invention provides a urethane acrylate composition. The urethane acrylate composition includes a resin system and a catalyst system. The resin system includes a urethane acrylate adduct including a reaction product of an isocyanate component and a functionalized acrylate reactive with the isocyanate component. The resin system also includes a first metal salt and a second metal salt. The catalyst system includes a peroxide.

The subject invention also provides a method of making a composite structure in a mold having a mold cavity. The method includes applying a first layer. The method also includes applying the urethane acrylate composition, described above, to form a support layer. The method further includes curing the composite structure in the mold cavity and demolding the composite structure from the mold cavity.

The resin system and the catalyst system can both be mixed in a spray applicator or by any other method of molding in which the resin system and the catalyst system are combined prior to application. The resin system, mixed with the catalyst system, allows the urethane acrylate composition of the present invention to gel and cure at room temperature within a short period of time, thereby providing a cured urethane acrylate composition with broad process control. Yet, gel times of greater than one hour are achievable, if desired. Curing the urethane acrylate composition at room temperature also reduces production costs because no high temperature ovens are needed, thus reducing energy useage and corresponding utility costs.

### DETAILED DESCRIPTION OF A PREFERRED EMBODIMENT

A urethane acrylate composition, according to the present invention, is used to make a variety of composite structures including boats, automotive parts, and building supplies. The urethane acrylate composition includes a resin system and a catalyst system. The catalyst system is described additionally below.

The resin system includes a urethane acrylate adduct. The urethane acrylate adduct includes a reaction product of an isocyanate component and a functionalized acrylate, described additionally below. The isocyanate component preferably includes at least two reactive isocyanate functional groups. Preferably, the aromatic isocyanate component includes, but is not limited to, methylene diphenyl diisocyanate, toluene diisocyanate, polymethylene phenyl polyisocyanate, and mixtures thereof. Most preferably, the isocyanate component includes polymethylene diphenyl diisocyanate and is commercially available from BASF Corporation of Wyandotte, Mich. under the trade name of Lupranate® M20S Isocyanate. It is to be understood that other isocyanate components may also be used including, but not limited to, hexamethylene diisocyanate, isophorone diisocyanate, other aliphatic isocyanates, modified aliphatic and aromatic isocyanates, isocyanate based quasi-prepolymers, and combinations thereof. Preferably, the isocyanate component is present in an amount of from 10 to 50, more preferably of from 25 to 44, and most preferably of from 32 to 35.4 parts by weight per 100 parts by weight of the resin system exclusively.

Referring now to the functionalized acrylate first introduced above, the functionalized acrylate is reactive with the isocyanate component to form the urethane acrylate adduct. More specifically, the functionalized acrylate is reactive with an isocyanate group of the isocyanate component. That is, reactive functional groups pendent to the functionalized acrylate are reactive with the isocyanate group of the isocyanate component. Preferably, the functionalized acrylate is selected from the group of hydroxy-functionalized acrylates, amine-functionalized acrylates, and combinations thereof. More preferably, the functionalized acrylate is selected from a group of hydroxy-functionalized acrylates. Most preferably, the functionalized acrylate includes hydroxyethyl methacrylate and is commercially available from Degussa of Piscataway, N.J. under the trade name of Mhioromer® BM905. It is understood by those in the art that the terminology functionalized acrylates and hydroxy-functional acrylates include hydroxyalkyl alkacrylates. Preferably, the functionalized acrylate is present in an amount of from 50 to 90, more preferably of from 56 to 75, and most preferably of from 64.6 to 68 parts by weight per 100 parts by weight of the resin system exclusively.

The resin system also includes a first metal salt. The first metal salt promotes a surface curing of the composite structures. Without intending to be bound or limited by any particular theory, it is believed that the first metal salt interacts with a second metal salt, described further below, to help promote a ligand exchange or a formation of a coordination complex in oxidative curing of the second metal salt. Preferably, the first metal salt includes, but is not limited to, a metal carboxylate. Most preferably, the first metal salt includes potassium octoate and is commercially available from Air Products and Chemicals, Inc. of Allentown, Pa. under the trade name of DABCO® K-15. Preferably, the first metal salt is present in an amount of from 0.005 to 1, more preferably of from 0.025 to 0.075, and most preferably of from 0.012 to 0.013 parts by weight per 100 parts by weight of the resin system exclusively.

The resin system also includes a second metal salt. Without intending to be bound or limited by any particular theory, it is believed that the second metal salt interacts with the first metal salt and aids in an oxidative surface curing the urethane acrylate composition. Preferably, the second metal salt includes, but is not limited to, a metal carboxylate. However, other metal salts that are not metal carboxylates are also contemplated for use herein. One example of another metal salt that is not a metal carboxylate includes cobalt naphthenate. More preferably, the second metal salt includes an oxidizable transition metal carboxylate. Most preferably, the second metal salt includes cobalt carboxylate and is commercially available from OM Group Inc. of Cleveland, Ohio, under the trade name of 12% Cobalt Cem-All®. Preferably, the second metal salt is present in an amount of from 0.01 to 1, more preferably of from 0.05 to 0.75, and most preferably of from 0.1 to 0.5 parts by weight per 100 parts by weight of the resin system exclusively.

Generally, the catalyst system, introduced above as part of the urethane acrylate composition, catalyzes a free radical reaction of the urethane acrylate composition. More specifically, it catalyzes the free radical reaction of an unsaturated functionality of the urethane acrylate composition with another unsaturated functionality of the urethane acrylate composition and/or of an unsaturated monomer to form the composite article. It is contemplated that the unsaturated monomer includes the functionalized acrylate. The catalyst system also allows the urethane acrylate composition to cure at room temperature within a short period of time.

The catalyst system includes a peroxide. Without intending to be bound or limited by any particular theory, it is believed that the peroxide serves as a source of free radicals through an interaction with the second metal salt as described above and alternatively with the second metal salt and an accelerator, described further below. The free radicals generated allow polymerization to occur via a free-radical polymerization mechanism. Preferably the peroxide includes, but is not limited to, an organic peroxide. Most preferably, the peroxide includes cumene hydroperoxide and is commercially available from Witco of Marshall, Tex. under the trade name of CHP-5. Preferably, the peroxide is present in an amount of from 0.5 to 4, more preferably of from 0.5 to 3, and most preferably of from 1 to 2.25 parts by weight per 100 parts by weight of the resin system exclusively.

The catalyst system may also include an accelerator. Without intending to be bound or limited by any particular theory, it is believed that the accelerator forms a coordination complex with the first metal salt and/or the second metal salt to increase a rate of peroxide decomposition thus accelerating the free radical polymerization reaction cross-linking the urethane acrylate composition. If included, the accelerator preferably includes, but is not limited to, an accelerator selected from the group of anilines, amines, amides, pyridines, and combinations thereof. However, other accelerators that are not selected from the group of anilines, amines, amides, and pyridines are also contemplated for use herein. One example of an accelerator that is not selected from the group of anilines, amines, amides, and pyridines includes acetylacetone. More preferably, the accelerator, if included, includes a dimethyl toluidine or a dialkyl aniline. Most preferably, the accelerator, if included, includes N,N-dimethyl-p-toluidine, N,N-diethylaniline, N,N-dimethylaniline, and combinations thereof. The most preferred accelerator is selected based on a desired gel time. N,N-dimethyl-p-toluidine is selected for fast gel times of less than 5 minutes. N,N-diethylaniline and N,N-dimethylaniline are selected for slower gel times of greater than 5 minutes. If present, the accelerator is preferably present in an amount of from 0.01 to 0.5, more preferably of from 0.05 to 0.4, and most preferably of from 0.08 to 0.3 parts by weight per 100 parts by weight of the resin system exclusively. However, most preferably, the accelerator is not included in the catalyst system. Exclusion of the accelerator improves storage stability of the resin system.

The resin system may also include a reactive diluent. Addition of the reactive diluent may result in an increase in a hardness of the composite structures and an improvement in heat performance of the composite structures. The addition of the reactive diluent may also reduce a viscosity of the resin system to optimize use in spray applications and affect a wide variety of other physical properties not discussed herein. Also, the reactive diluent can alter rates of the curing reaction affecting gel times and an observed reaction exotherm. The reactive diluent may be added to the urethane acrylate composition prior to its formation or after the reaction of the isocyanate component and the functionalized acrylate to form the urethane acrylate composition is complete. It is believed that when the reactive diluent is added to the resin system prior to a formation of the urethane acrylate composition, the reactive diluent serves to decrease a rate of the reaction between the isocyanate component and the functionalized acrylate. Without intending to be bound or limited by any particular theory, it is believed that a decrease in the rate of the reaction between the isocyanate component and the functionalized acrylate is due to a dilution of the isocyanate component and the functionalized acrylate.

Preferably, the reactive diluent may include, but is not limited to, alkyl alkacrylates. However, other reactive diluents that are not alkyl alkacrylates are also contemplated for use herein. Examples of reactive diluents that are not alkyl alkacrylates include, but are not limited to, styrene, ac-methylstyrene, and vinyl alcohol alkoxylates. Most preferably, though, the reactive diluent includes methyl methacrylate. It is understood by those in the art that the terminology “alkyl alkacrylates” includes alkyl acrylates. If included, it is preferred that the reactive diluent is present in an amount of from 5 to 50, more preferably of from 5 to 20, and most preferably of from 7 to 15 parts by weight per 100 parts by weight of the resin system exclusively. It is to be understood that the reactive diluent becomes part of the resin system and thus impacts the amounts of each component of the catalyst system whether added to the resin system or integrated into the catalyst system.

It is also to be understood that the reduction in viscosity of the resin system can also be accomplished with inclusion of a non-reactive diluent such as an organic solvent, and specifically, acetone. Non-reactive diluents can be included in the resin system if the composite article's physical and performance properties are acceptable.

Further, the reduction in viscosity of the resin system can also be accomplished by heating the resin system. The resin system can be heated if a potential impact on the physical properties of the composite article and a potential resin reactivity and stability are acceptable.

The resin system may also include a gel time retarder. Addition of the gel time retarder decreases a gel time of the urethane acrylate composition. If included, the gel time retarder is preferably selected from the group of diones, naphthenates, styrenes, and combinations thereof. Most preferably, if included, the gel time retarder includes 2,4-pentanedione. If included, it is preferred that the gel time retarder is included in an amount of from 0.01 to 0.3, more preferably of from 0.05 to 0.2, and most preferably of from 0.1 to 0.2 parts by weight per 100 parts by weight of the resin system exclusively.

The resin system may also include an additive. If included, the additive is preferably selected from the group of air releasing agents, wetting agents, surface modifiers, waxes, inert inorganic fillers, reactive inorganic fillers, chopped glass, other types of glass such as glass mat, and combinations thereof. Most preferably, the additive includes a polysiloxane as the air releasing agent and calcium carbonate as the inert inorganic filler. The air releasing agent is commercially available from BYK Chemie under the trade name of BYK®-067 and serves to reduce entrapped air bubbles within the urethane acrylate composition during preparation of the composite articles. If included, it is preferred that the antifoam additive is present in an amount of from 0.05 to 1, and most preferably of from 0.05 to 0.5 parts by weight per 100 parts by weight of the resin system exclusively

If included, the calcium carbonate is commercially available from OMYA Inc, of Proctor, Vt. under the trade name as Omyacarb® 4 and is believed to influence homogeneity, strength, shrinkage, and mechanical properties of the urethane acrylate composition. If included, it is preferred that the calcium carbonate is present in an amount of from greater than 0 to 70, more preferably of from 20 to 55, and most preferably of from 25 to 45 parts by weight per 100 parts by weight of the resin system exclusively.

The catalyst system may also include an inert diluent. The inert diluent allows for ease of handling and accurate delivery of the catalyst system. Preferably, the inert diluent includes, but is not limited to, plasticizers. Most preferably, the inert diluent includes 2,2,4-trimethyl-1,3-pentane diisobutyrate which is selected for reduced volatility. However, other inert diluents are also contemplated for use herein. Examples of other inert diluents include acetone and diisonyl phthalate. Most preferably, though, the 2,2,4-trimethyl-1,3-pentane diisobutyrate is commercially available from Eastman Chemical Company under the trade name of Kodaflex® TXIB. If included, it is preferred that the inert diluent is present in an amount of from 50 to 90, more preferably of from 75 to 85, and most preferably from 83 to 84 parts by weight per 100 parts by weight of the resin system exclusively.

The subject invention further provides a method of catalyzing the urethane acrylate composition. The method includes providing the catalyst system described above. Once the catalyst system is provided, the catalyst system is added to the resin system for spray, pour, and molded applications.

The subject invention also includes a method of making a composite structure in a mold having a mold cavity. It is contemplated that the mold includes both an open mold and a closed mold. Preferably, the mold cavity is coated or initially lined with a known mold release agent to facilitate the eventual demolding of the composite structure.

Generally, the method of making the composite structure in the mold includes applying a first layer. The method also includes applying the urethane acrylate composition to form a support layer.

Preferably, the method of making the composite structure in the mold includes applying a first layer to a mold cavity. The first layer may be a show surface of the composite structure. The first layer is typically a styrenated polyester gel coat. Preferably, the first layer is cured at room temperature of about 77° F. for a length of time sufficient to prevent bleeding and read through of subsequent layers, but not so long as to prevent bonding. Typically, the first layer is cured for about one hour. However, shorter cure times can be achieved if the first layer is a urethane acrylate.

This method also preferably includes applying the urethane acrylate composition to the first layer to form a support layer wherein the urethane acrylate composition includes the resin system and the catalyst system. Preferably, the resin system and the catalyst system are reacted in a volumetric ratio of from 100:1 to 100:4, typically in the spray application.

Although, as described above, the first layer is first applied to the mold cavity and the urethane acrylate composition is applied to the first layer, it is possible that, when forming the composite structure, the urethane acrylate composition is first applied to the mold cavity and the first layer is applied to the urethane acrylate composition.

The urethane acrylate composition has sufficiently low viscosity to enable mixing the urethane acrylate composition, specifically mixing the resin system and the catalyst system, in a spray applicator prior to application of the urethane acrylate composition onto the first layer of the composite structure. The resin system provides a composition, that, when mixed with the catalyst system, allows the urethane acrylate composition to cure within a short period of time at room temperature regardless of a thickness of the urethane acrylate composition. Preferably, the urethane acrylate composition ranges in a thickness of from 0.01 to 1 inches, more preferably of from 0.1 to 1 inches, and most preferably of from 0.125 to 1 inches. It is to be appreciated that the urethane acrylate composition may also be applied through pouring, injection, VARTM, RIM, infusion mold casting, and open mold casting. However, use of the spray applicator is preferred for certain composite articles.

Alternatively, additives such as chopped glass and/or glass mat may also be added to the resin system as the resin system is mixed with the catalyst system. As is known in the art, the chopped glass can be added to the resin system by feeding a glass roving into an air driven chopper or cutter motor attached to the spray applicator. Further, once the chopped glass and/or glass mat is added to the resin system, the glass may be rolled or pressed into the urethane acrylate composition, which, if repeated, can build up multiple layers.

In another embodiment, the urethane acrylate composition is applied to the mold to form the support layer and demolded prior to forming the first layer. The first layer is then formed on the support layer outside of the mold in a post-production operation.

The following examples generally illustrate the nature of the invention and are not to be construed as limiting the invention. Unless otherwise indicated, all parts are given as parts by weight.

### EXAMPLES

Urethane acrylate compositions are used to form a support layer used in conjunction with a first layer of a composite structure. The support layer is formed from a urethane acrylate composition that is the reaction product of an isocyanate component and a functionalized acrylate reactive with the isocyanate component. The isocyanate component includes isocyanate groups that are reactive with reactive functional groups pendent to the functionalized acrylate. The functionalized acrylates and hydroxy-functional acrylates include hydroxy-alkyl alkacrylates that react with at least one of the isocyanate groups of the isocyanate component. Specific components included in the urethane acrylate composition are set forth in Table 1.

TABLE 1

| | Ex. 1 | Ex. 2 | Ex. 3 | Ex. 4 | Ex. 5 | Ex. 6 | Ex. 7 | Ex. 8 |
|---|---|---|---|---|---|---|---|---|
| Functionalized | 83.770 | 83.680 | 83.845 | 52.104 | 52.000 | 51.920 | 51.592 | 82.800 |
| Urethane Acrylate | | | | | | | | |
| Adduct A | | | | | | | | |
| Functionalized | | | | | | | | |
| Urethane Acrylate | | | | | | | | |
| Adduct B | | | | | | | | |
| Reactive Diluent A | 14.783 | 14.767 | 14.796 | 8.132 | 8.116 | 8.103 | 8.052 | 14.612 |
| Reactive Diluent B | | | | | | | | |
| Reactive Diluent C | | | | | | | | |
| Additive | | | | 37.709 | 37.633 | 37.575 | 37.338 | |
| Accelerator A | | | 0.103 | | | | | |
| Accelerator B | | | | | | | | 0.235 |
| Accelerator C | 0.203 | 0.299 | | | | | | |
| Second Metal Salt A | 0.099 | 0.099 | 0.099 | 0.095 | 0.297 | 0.303 | 0.097 | |
| Second Metal Salt B | | | | | | | | 0.392 |
| Peroxide A | 0.997 | 1.008 | 1.009 | 1.960 | 1.955 | 1.974 | 2.920 | 1.960 |
| Gel Time Retarder A | | | | | | | | |
| Gel Time Retarder B | | | | | | | | |
| First Metal Salt | 0.148 | 0.148 | 0.148 | | | 0.125 | | |
| Total: | 100.000 | 100.001 | 100.000 | 100.000 | 100.001 | 100.000 | 99.999 | 99.999 |
| Resin, ° C. | 27.4 | 26.8 | 26.8 | 25.8 | 25.6 | 26.6 | 24.4 | 23.8 |
| Gel Time, Minutes | 5.17 | 5.22 | 2.50 | 28.50 | 12.07 | 14.05 | 44.00 | 19.50 |
| Peak Exotherm, ° C. | 166 | 174 | 177 | 127 | 120 | 123 | 109 | 175 |
| | Ex. 9 | Ex. 10 | Ex. 11 | Ex. 12 | Ex. 13 | Ex. 14 | Ex. 15 | Ex. 16 |
| Functionalized | 81.683 | 82.273 | 96.451 | 98.426 | 98.505 | 94.542 | | |
| Urethane Acrylate | | | | | | | | |
| Adduct A | | | | | | | | |
| Functionalized | | | | | | | 68.509 | 68.532 |
| Urethane Acrylate | | | | | | | | |
| Adduct B | | | | | | | | |
| Reactive Diluent A | 14.415 | 14.519 | | | | | 14.032 | 14.037 |
| Reactive Diluent B | | | | | | | 15.024 | |
| Reactive Diluent C | | | | | | | | 15.034 |
| Additive | | | | | | | | |
| Accelerator A | | | | | | | | |
| Accelerator B | 0.388 | 0.101 | | | | | | |
| Accelerator C | | | | | | | | |
| Second Metal Salt A | | | 0.241 | 0.394 | 0.296 | 0.305 | 0.210 | 0.207 |
| Second Metal Salt B | 0.582 | 0.194 | | | | | | |
| Peroxide A | 2.931 | 2.913 | 2.912 | 0.984 | | 1.966 | 1.964 | 1.951 |
| Gel Time Retarder A | | | 0.145 | 0.148 | | | | |
| Gel Time Retarder B | | | | | | 2.948 | | |
| First Metal Salt | | | 0.251 | 0.049 | 0.201 | 0.239 | 0.261 | 0.240 |
| Total: | 99.999 | 100.000 | 100.000 | 100.001 | 99.002 | 100.000 | 100.000 | 100.001 |
| Resin, ° C. | 25.4 | 25.0 | 26.4 | 26.2 | 25.0 | 26.8 | 26.8 | 25.6 |
| Gel Time, Minutes | 11.75 | 28.00 | 22.00 | 240.00 | 8.82 | 18.72 | 8.70 | 6.93 |
| Peak Exotherm, ° C. | 179 | 181 | 184 | 153 | 166 | 157 | 156 | 160 |

TABLE 2

| | Comparative | Comparative | Comparative | Comparative |
|---|---|---|---|---|
| | Ex. A | Ex. B | Ex. C | Ex. D |
| Resin | Resin G | Resin A | Resin A | Resin B |
| Catalyst Type | MF-104-50 | Peroxide B | Peroxide B | Peroxide B |
| Catalyst Concentration | 1.50% | 1.35% | 1.35% | 2.00% |
| Resin Concentration | 98.50% | 98.65% | 98.65% | 98.00% |
| Total | 100% | 100% | 100% | 100% |
| Gel Time (minutes) | 26.00 | 20.33 | 17.50 | 54.45 |
| Maximum temperature, ° C. | 81.10 | 142.78 | 150.00 | 145.56 |
| | Comparative | Comparative | Comparative | Comparative |
| | Ex. E | Ex. F | Ex. G | Ex. H |
| Resin | Resin C | Resin D | Resin E | Resin F |
| Catalyst Type | Hardener | Peroxide B | Peroxide B | Peroxide A |
| Catalyst Concentration | 50.00% | 1.50% | 2.00% | 2.00% |
| Resin Concentration | 50.00% | 98.50% | 98.00% | 98.00% |
| Total | 100.00% | 100% | 100% | 100% |
| Gel Time (minutes) | 77.00 | 27.00 | 15.00 | 55.17 |
| Maximum temperature, ° C. | 25.00 | 105.56 | 136.11 | 136.11 |

Functionalized Urethane Acrylate Adduct A is a reaction product of 2.0:1.0 reactive molar equivalents of hydroxyethyl methacrylate and polymeric methylene diphenyl diisocyanate.

Functionalized Urethane Acrylate Adduct B is the reaction product of 1.1:1.0 reactive molar equivalents of hydroxyethyl methacrylate and polymeric methylene diphenyl diisocyanate.

Resin A is HAF Neat Polyester commercially available from Reichold of Morris, Ill. under the trade name Polylite® 33197-00.

Resin B is a unsaturated polyester resin commercially available from Ashland Chemical, Columbus, Ohio under the trade name LV6541-004.

Resin C is a Two Component Epoxy Resin commercially available from Michigan Fiberglass of St. Clair Shores, Mich.

Resin D is Neat Polyester Resin commercially available from AOC, LLC, Collierville Tenn. under the trade name C668-BAB-14.

Resin E is DCPD resin commercially available from Eastman Chemicals of Carpentersville, Ill. under the trade name Eastman UP Resin 732.

Resin F is Vinyl ester resin commercially available from Eastman Chemicals, Kingsport, Tenn. under the trade name Eastman 784-7975.

Resin G is a fully promoted vinyl ester commercially available from Michigan Fiberglass of St. Clair Shores, Mich. under the trade name Vinyl Ester MFV 104 (promoted).

Peroxide A is cumene hydroperoxide and is commercially available from Crompton Corporation of Middlebury, Conn. under the trade name of CHP-5.

Peroxide B is methylethylketone peroxide commercially available from Crompton Corporation of Middlebury, Conn. under the trade name of HPC-9.

MF-104-50 is methylethylketone peroxide commercially available from Michigan Fiberglass of St. Clair Shores, Mich. under the trade name MF-104-50.

Hardener is a commercially available two-component epoxy hardener available from Michigan Fiberglass of St. Clair Shores, Mich.

First Metal Salt is potassium octoate, commercially available from Air Products and Chemicals, Inc. of Allentown, Pa. under the trade name of DABCO® K-15.

Second Metal Salt A is cobalt carboxylate, commercially available from OM Group, Inc of Cleveland, Ohio, under the trade name of 12% Cobalt Cem-All®.

Second Metal Salt B is cobalt naphthenate, commercially available from OMG America, Inc of Cleveland, Ohio, under the trade name of 6% Cobalt NAP-ALL®.

Additive is calcium carbonate commercially available from OMYA Inc, of Proctor, Vt. under the trade name as Omyacarb® 4.

Reactive diluent A is methyl methacrylate available from Degussa Corp./Rohm America LLC. of Piscataway, N.J. under the trade name Methyl Methacrylate.

Reactive diluent B is Cyclohexyl methacrylate available from Degussa Corp./Rohm America LLC. of Piscataway, N.J. under the trade name MHOROMER® BM711.

Reactive diluent C is 1,4-butanediol dimethacrylate available from Degussa Corp./Rohm America LLC. of Piscataway, N.J. under the trade name MHOROMER® MFM 405.

Gel time retarder A is 2,4-pentanedione available from Sigma-Aldrich of Saint Louis, Mo. under the trade name 2,4-pentanedione.

Gel time retarder B is alpha methylstyrene available from Sigma-Aldrich of Saint Louis, Mo. under the trade name alpha methylstyrene.

Accelerator A is N, N-dimethyl-p-toluidine available from Sigma-Aldrich of Saint Louis, Mo. under the trade name N,N-Dimethyl-p-Toluidine.

Accelerator B is dimethyl aniline available from ACETO Corporation of Lake Success, N.Y. under the trade name N,N-Dimethyl Aniline.

Accelerator C is diethyl aniline available from Sigma-Aldrich of Saint Louis, Mo. under the trade name N,N-Diethylaniline.

The invention has been described in an illustrative manner, and it is to be understood that the terminology which has been used is intended to be in the nature of words of description rather than of limitation. Obviously, many modifications and variations of the present invention are possible in light of the above teachings, and the invention may be practiced otherwise than as specifically described.

What is claimed is:

1. A urethane acrylate composition comprising:
(A) a resin system comprising;
(i) a urethane acrylate adduct comprising the reaction product of;
(a) an isocyanate component, and
(b) a functionalized acrylate reactive with said isocyanate component,
(ii) a first metal salt, and
(iii) a second metal salt; and
(B) a catalyst system comprising a peroxide.

2. A urethane acrylate composition as set forth in claim 1 wherein said first metal salt comprises a metal carboxylate.

3. A urethane acrylate composition as set forth in claim 2 wherein said metal carboxylate comprises potassium octoate.

4. A urethane acrylate composition as set forth in claim 1 wherein said second metal salt comprises a metal carboxylate.

5. A urethane acrylate composition as set forth in claim 4 wherein said metal carboxylate comprises cobalt carboxylate.

6. A urethane acrylate composition as set forth in claim 1 wherein said peroxide comprises an organic peroxide.

7. A urethane acrylate composition as set forth in claim 6 wherein said organic peroxide comprises cumene hydroperoxide.

8. A urethane acrylate composition as set forth in claim 1 wherein said resin system further comprises a reactive diluent.

9. A urethane acrylate composition as set forth in claim 8 wherein said reactive diluent comprises an alkyl alkacrylate.

10. A urethane acrylate composition as set forth in claim 9 wherein said alkyl alkacrylate comprises methyl methacrylate.

11. A urethane acrylate composition as set forth in claim 1 wherein said resin system further comprises a gel time retarder.

12. A urethane acrylate composition as set forth in claim 11 wherein said gel time retarder comprises 2,4-pentanedione.

13. A urethane acrylate composition as set forth in claim 1 wherein said functionalized acrylate is selected from the group of hydroxy-functional acrylates, amine-functional acrylates, and combinations thereof.

14. A urethane acrylate composition as set forth in claim 13 wherein said functionalized acrylate comprises hydroxyethyl methacrylate.

15. A urethane acrylate composition as set forth in claim 1 wherein said isocyanate component has at least two reactive functional groups.

16. A urethane acrylate composition as set forth in claim 15 wherein said isocyanate component is selected from the group of methylene diphenyl diisocyanates, toluene diisocyanates, polymethylene phenyl isocyanates, and combinations thereof.

17. A urethane acrylate composition as set forth in claim 1 wherein said catalyst system further comprises an inert diluent.

18. A urethane acrylate composition as set forth in claim 17 wherein said inert diluent comprises 2,2,4-trimethyl-1,3-pentanediol diisobutyrate.

19. A urethane acrylate composition as set forth in claim 1 wherein said catalyst system further comprises an accelerator.

20. A urethane acrylate composition as set forth in claim 1 wherein said resin system further comprises an additive selected from the group of air releasing agents, wetting agents, surface modifiers, waxes, inert inorganic fillers, reactive inorganic fillers, chopped glass, glass mat, and combinations thereof.

21. A urethane acrylate composition as set forth in claim 1 wherein said first metal salt comprises potassium octoate, said second metal salt comprises cobalt carboxylate, said peroxide comprises cumene hydroperoxide, said functionalized acrylate comprises hydroxyethyl methacrylate, and said isocyanate component comprises polymethylene phenyl polyisocyanate.

22. A urethane acrylate composition as set forth in claim 1 wherein said first metal salt is present in an amount of from 0.025 to 0.075 parts by weight per 100 parts by weight of said resin system.

23. A urethane acrylate composition as set forth in claim 1 wherein said second metal salt is present in an amount of from 0.05 to 0.75 parts by weight per 100 parts by weight of said resin system.

24. A urethane acrylate composition as set forth in claim 1 wherein said peroxide is present in an amount of from 0.5 to 3 parts by weight per 100 parts by weight of said resin system.

25. A urethane acrylate composition as set forth in claim 1 wherein said functionalized acrylate is present in an amount of from 56 to 75 parts by weight per 100 parts by weight of said resin system.

26. A urethane acrylate composition as set forth in claim 1 wherein said isocyanate component is present in an amount of from 25 to 44 parts by weight per 100 parts by weight of said resin system.

27. A method comprising the steps of:
(A) providing a resin system comprising;
(i) a urethane acrylate adduct comprising the reaction product of;
(a) an isocyanate component, and
(b) a functionalized acrylate reactive with said isocyanate component,
(ii) a first metal salt, and
(iii) a second metal salt; and
(B) providing a catalyst system comprising a peroxide; and
(C) combining the resin system and the catalyst system to form a urethane acrylate composition.

28. A method as set forth in claim 27 wherein the step of combining the resin system and the catalyst system comprises applying the catalyst system with the resin system.

29. A method as set forth in claim 28 wherein the step of applying the catalyst system with the resin system comprises spraying the catalyst system with the resin system.

30. A method as set forth in claim 27 wherein the first metal salt comprises a metal carboxylate.

31. A method as set forth in claim 30 wherein the metal carboxylate comprises potassium octoate.

32. A method as set forth in claim 27 wherein the second metal salt comprises a metal carboxylate.

33. A method as set forth in claim 32 wherein the metal carboxylate comprises cobalt carboxylate.

34. A method as set forth in claim 27 wherein the peroxide comprises an organic peroxide.

35. A method as set forth in claim 34 wherein the organic peroxide comprises cumene hydroperoxide.

36. A method as set forth in claim 27 wherein the first metal salt is present in an amount of from 0.025 to 0.075 parts by weight per 100 parts by weight of the resin system.

37. A method as set forth in claim 27 wherein the second metal salt is present in an amount of from 0.05 to 0.75 parts by weight per 100 parts by weight of the resin system.

38. A method of making a composite structure in a mold having a mold cavity, said method comprising the steps of:
(A) applying a first layer;
(B) applying a urethane acrylate composition to form a support layer, wherein the urethane acrylate composition comprises;
a resin system comprising;
(i) a urethane acrylate adduct comprising the reaction product of;
(a) an isocyanate component, and
(b) a functionalized acrylate reactive with said isocyanate component,
(ii) a first metal salt,
(iii) a second metal salt; and
a catalyst system comprising a peroxide;
(C) curing the composite structure in the mold cavity; and
(D) demolding the composite structure from the mold cavity.

39. A method of making a composite structure as set forth in claim 38 wherein said step of applying the urethane acrylate composition comprises spraying the urethane acrylate composition.

40. A method of making a composite structure as set forth in claim 39 wherein said step of applying the urethane acrylate composition further comprises providing a supply of the resin system independent from a source of the catalyst system.

41. A method of making a composite structure as set forth in claim 40 wherein said step of applying the urethane acrylate composition further comprises mixing the resin system and the catalyst system in a spray applicator prior to application of the urethane acrylate composition.

42. A method of making a composite structure as set forth in claim 38 wherein said step of applying the urethane acrylate composition comprises reacting the resin system and the catalyst system in a volumetric ratio of from 100:1 to 100:4.

43. A method of making a composite structure as set forth in claim 38 wherein the first metal salt comprises potassium octoate.

44. A method of making a composite structure as set forth in claim 38 wherein the second metal salt comprises cobalt carboxylate.

45. A method of making a composite structure as set forth in claim 38 wherein the peroxide comprises cumene hydroperoxide.

46. A method of making a composite structure as set forth in claim 38 wherein the resin system further comprises a reactive diluent.

47. A method of making a composite structure as set forth in claim 46 wherein the reactive diluent comprises methyl methacrylate.

48. A method of making a composite structure as set forth in claim 38 wherein the functionalized acrylate comprises hydroxyethyl methacrylate.

49. A urethane acrylate composition as set forth in claim 38 wherein the resin system further comprises a gel time retarder.

50. A urethane acrylate composition as set forth in claim 49 wherein the gel time retarder comprises 2,4-pentanedione.

51. A method of making a composite structure as set forth in claim 38 wherein the isocyanate component is selected from the group of methylene diphenyl diisocyanates, toluene diisocyanates, and combinations thereof.

52. A method of making a composite structure as set forth in claim 38 wherein the catalyst system further comprises an inert diluent.

53. A method of making a composite structure as set forth in claim 52 wherein the inert diluent comprises 2,2,4-trimethyl-1,3-pentanediol diisobutyrate.

54. A method of making a composite structure as set forth in claim 38 wherein the resin system further comprises an additive selected from the group of air releasing agents, wetting agents, surface modifiers, waxes, inert inorganic fillers, reactive inorganic fillers, chopped glass, and combinations thereof.

55. A method of making a composite structure as set forth in claim 38 wherein the first metal salt is present in an amount of from 0.025 to 0.075 parts by weight per 100 parts by weight of the resin system.

56. A method of making a composite structure as set forth in claim 38 wherein the second metal salt is present in an amount of from 0.05 to 0.75 parts by weight per 100 parts by weight of the resin system.

57. A method of making a composite structure as set forth in claim 38 wherein the peroxide is present in an amount of from 0.50 to 3 parts by weight per 100 parts by weight of the resin system.

58. A method of making a composite structure as set forth in claim 38 wherein the functionalized acrylate is present in an amount of from 56 to 75 parts by weight per 100 parts by weight of the resin system.

59. A method of making a composite structure as set forth in claim 38 wherein the isocyanate component is present in an amount of from 25 to 44 parts by weight per 100 parts by weight of the resin system.

60. A method of making a composite structure as set forth in claim 38 wherein said step of applying the first layer comprises applying the first layer to the mold cavity.

61. A method of making a composite structure as set forth in claim 60 wherein said step of applying the urethane acrylate composition comprises applying the urethane acrylate composition to the first layer.
